(19) United States
(12) Patent Application Publication
(10) Pub. No.: US 2004/0258105 A1
(43) Pub. Date: Dec. 23, 2004

(54) Building optical network

(76) Inventors: Matthew T. Spathas, San Diego, CA (US); Stephen B. Williams, La Jolla, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/600,892

(22) Filed: Jun. 19, 2003

(51) Int. Cl. H04L 12/28

(52) U.S. Cl. 370/539

(57) ABSTRACT

A high speed, fiber optics communications network provides network connectivity throughout a multi-tenant building or facility and is integrated with other building systems. Network management and maintenance are automated and centralized in a network manager. Network bandwidth needs of the building are aggregated and delivered to building tenants as needed. Wireless LAN access points are coupled to the network to provide wireless network access throughout the building.

### FIELD OF THE INVENTION

The present invention relates to network design, construction and deployment in commercial buildings and, in particular, relates to an integrated Building Optical Network (“BON”) that (i) aggregates bandwidth; (ii) automates IT; (iii) integrates building systems; and (iv) enables Wi-Fi (wireless).

### BACKGROUND OF THE INVENTION

The real estate industry has historically made bold and innovative moves to better serve its customers. The movements from stairs to elevators, kerosene to electricity and windows to air conditioning, as well as the provision of security and amenities, are just a few examples of the innovative moves championed by the real estate industry. Multiple third party networks inside a building are inefficiently designed and distribute bandwidth inefficiently, and do not enable automation of IT, integration of building systems and complete Wi-Fi deployment. The real estate industry, in its technological infancy, has not yet addressed the problems posed by multiple third party networks inside of buildings.

Typically, each tenant or occupant in a multi-tenant facility such as an office building makes its own carrier arrangements. To provide a service, a third party provider must construct a data network in the building. The network is built (and changed) piecemeal by the third party providers and/or tenants with no unified plan or underlying infrastructure. The building owner may be completely unaware of the third party network infrastructure and connections in his own building, much of which may be undocumented, inefficiently laid out and installed, and perhaps without any legal access rights.

Consequently, the provision of network access and bandwidth is unnecessarily expensive for both the tenants and building owner. As used in this application, “bandwidth” means communications services, such as Internet access, telephone, voice and data services, that must be contracted for with an outside service provider. Smaller tenants with smaller networks and bandwidth demands will typically not have the leverage (in the form of an expected high volume of usage) to negotiate favorable pricing terms.

The building owner, while not faced with the capital cost of installing and maintaining the networks, is faced with an ever-increasing amount of often undocumented network infrastructure running through his building. Removal of such infrastructure can be costly, simply in the time spent distinguishing functioning infrastructure and wiring from abandoned, non-functioning infrastructure and wiring. The presence of piecemeal and undocumented networks throughout the building does not add to the building's resale value and may even detract from it.

The lack of an integrated communications network in multi-tenant buildings has many additional drawbacks. Tenants may not have access to the latest technology due to their reluctance to make the necessary capital investments in their network. Most tenants, for example, will be reluctant to build a costly fiber optic network, and will therefore miss the speed and reliability provided by such a network. Instead, to minimize costs, they will make do with a less reliable and slower network. The lack of an integrated network also removes the capability for a building owner to provide network maintenance and troubleshooting services to its tenants.

### SUMMARY OF THE INVENTION

The Building Optical Network (“BON”) of the present invention is a standards-based, common, agnostic network that is owned by the building owner. The BON reduces costs to the building owner and tenants by: (i) aggregating bandwidth (provided as a “fourth utility”); (ii) automating IT; (iii) integrating building systems; and (iv) enabling Wi-Fi (wireless). The BON is a unique, standards-based “agnostic” infrastructure that is preferably owned by the building owner and managed by a third party for the benefit of the tenants. Water, gas and electricity are delivered to multi-tenant buildings as utilities. The BON of the present invention permits delivery of a fourth utility: greater bandwidth at a significantly lower cost.

The present invention provides numerous advantages. Greater speed, reliability and increased bandwidth is provided by the present invention. Each tenant or occupant of the building has direct access to high speed and high capacity broadband services, including Internet, e-mail, data, voice, video and other services. The communications infrastructure for an entire building is efficiently and rapidly installed, managed and controlled by a single entity. The communications infrastructure may be integrated with the security, safety and other building systems infrastructure into one comprehensive and unified network. Management and maintenance of the BON may be automated and outsourced to an IT specialist, providing tenants with a single point of contact for all of their network issues. With a BON serving an entire building, upgrades can be made in a cost effective matter to keep pace with the latest in technology.

With the BON of the present invention, the buying power of the entire building can be advantageously used to negotiate better telephone, Internet access, etc. rates from outside carriers. Carriers compete at the street, not in the building, for the opportunity to make a bulk sale of bandwidth to the building owner for the benefit of all tenants. Tenants have immediate “plug and play” access from their first day of occupancy with no capital investment in, or planning of, the network infrastructure.

Significant benefits flow to the building owner and third party carriers as well. The carriers avoid the costs of building piecemeal networks in buildings to service individual tenants, and gain the opportunity to a make a bulk bandwidth sale to service the needs of an entire building. With respect to the building owner, the presence of a hi-tech, integrated, completely mapped and documented optical network will significantly increase the retail value of the building. Just as a building owner owns the electrical wires, transformers and elevators in his building, he owns the BON. Bandwidth (data) is then deployed in the building in a similar fashion to the way that electricity is deployed. And, just as he hires Otis Elevators to manage and maintain the elevators, he hires a third party to manage and maintain the BON. The network is also a valuable amenity to potential tenants and will lead to increased occupancy at higher lease rates. This unprecedented and exclusive control over the entire building network infrastructure will undoubtedly present many other profit making opportunities to the building owner.

The BON of the present invention also enables the provisioning of Wi-Fi (802.11×) access throughout the entire building. Tenants, visitors and building staff (building management, security and engineers) will have access to the Wi-Fi network. The building-wide Wi-Fi network will enable such amenities as wireless Internet for tenants and visitors, wireless building security and camera surveillance systems, and wireless work order systems.

Accordingly, one embodiment of the invention is a method for providing network access to a building. A high speed, integrated communications network that provides network connectivity throughout the building is provided and integrated with other building systems. Network management and maintenance are automated and centralized in a network manager. The network bandwidth needs of the building are aggregated and delivered to building tenants as needed.

Another embodiment of the invention is a method for delivering network bandwidth as a utility to a multi-occupant facility. The design and installation of a high speed fiber optics communications network that provides wired and wireless network connectivity throughout the facility is coordinated. Network bandwidth is obtained in bulk to meet the bandwidth needs of all occupants of the facility and delivered to the occupants as needed. The method also comprises maintaining, managing and servicing the communications network.

Another embodiment of the invention is an integrated data communications network for an office building. A fiber optics network infrastructure and equipment provides network connectivity throughout the building, and there is a single point of access for provision of bandwidth by network service providers. Network management and maintenance is automated and centralized, and wireless LAN access points are configured to provide wireless network access throughout the building.

Additional features and aspects of this invention will be apparent after review of the following figures and detailed description, and are intended to be within the scope of this invention and protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram of an office building having a conventional network configuration and access scheme.

FIG. 2 is a block diagram of a building optical network according to the present invention.

FIG. 3 is a flow diagram illustrating a method for providing network access to a building according to the present invention.

FIG. 4 is a flow diagram illustrating a method for the provision of network infrastructure and access to a building by a network coordinator according to the present invention.

### DETAILED DESCRIPTION OF THE INVENTION

The present invention provides an integrated building optical network (“BON”) for providing efficient and high speed network access to all tenants of a building. It enables building owners to aggregate bandwidth; automate and centralize network maintenance and IT services; integrate building systems; and provide wireless LAN access (via Wi-Fi “hot spots”) throughout the building.

The invention is discussed primarily with reference to an office building, which is exemplary for illustrating the principles of the invention. It should be understood, however, that the term “building”, as used in this description, may include other locations or facilities where multiple points of access to a high speed network is desired. Other examples include, without limitation, apartment buildings, hotels, malls, warehouses and industrial facilities.

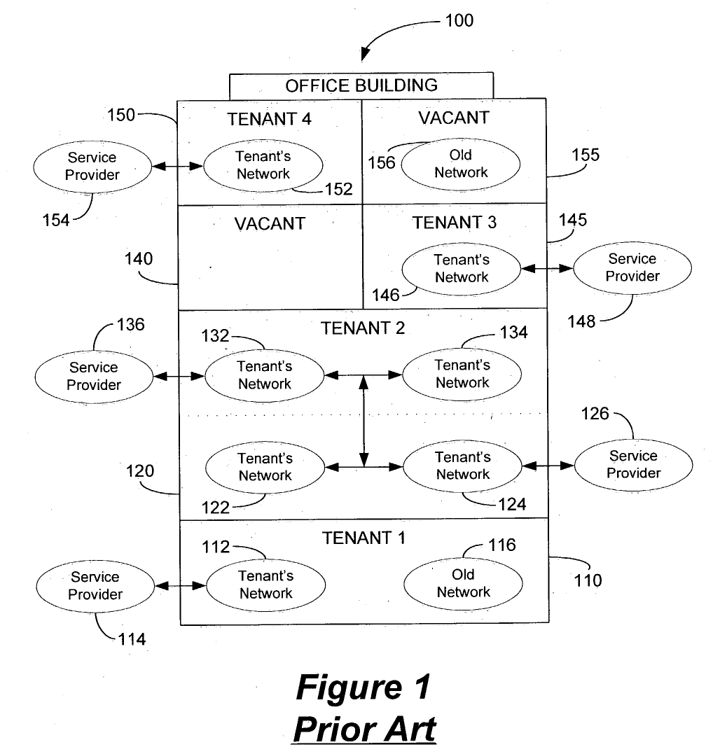

An office building 100 having a conventional network configuration and access scheme is depicted in FIG. 1; and serves to illustrate many of the problems and drawbacks inherent in conventional methods for providing network access to a multi-tenant facility. Building 100 has five floors. The first floor is occupied by a tenant 110 that has contracted with an outside service provider (carrier) 114 to provide a communications network 112 and associated network services, such as high speed Internet access, email and the like. The outside carriers may include, for example, Broadband Local Exchange Carriers (BLECs), Competitive Local Exchange Carriers (CLECs) and Digital Subscriber Line (DSL) providers.

The old communications network 116 used by the previous tenant of the first floor has been left behind. The current tenant was not able to use it or remove the wiring and other infrastructure, however, since the previous tenant left no documentation of old network 116.

The first floor tenant scenario calls attention to many of the problems inherent with conventional techniques for providing network access and bandwidth to an office building. Previously installed networks are often not usable, as there is usually no blueprint for the wiring and infrastructure left behind. They may not even be easily removable for fear of disrupting an active building network. Hence, the new tenant and/or a third party carrier must pay for the costs of building and designing a network from scratch, and the building owner must deal with increasing layers of old and undocumented wiring and infrastructure. The new tenant must also negotiate on his own with carriers and, unless the network volume is expected to be quite large, will usually not have significant leverage to negotiate favorable pricing terms. The new tenant must also hire qualified IT professionals to manage and service the network. A building having 30 individual tenants may also have 30 individual IT support staff, for example.

The second and third floors are occupied by another tenant 120. Tenant 120 has had a more complicated network installed, involving multiple components 122, 124, 132 and 134 extending and linked across several floors. The tenant has also contracted with two service providers 126 and 136 to provide needed network services. Hence, tenant 120 and its carriers will face even greater costs than tenant 110 in designing, installing and running its network.

The fourth floor is split between a vacant space 140 and a tenant 145. Tenant 145 is using a network 146 and has contracted with network service provider 148. The fifth floor is also split between a tenant 150 and a vacant space 155. Tenant 150 is using a network 152 and has contracted with service provider 154. Vacant space 155 includes old and undocumented network infrastructure 156 that will have to be dealt with by any new tenant or the building owner.

Hence, each tenant of office building 100 (or its bandwidth provider) has had to finance the design and installation of its own individual network and has little leverage to negotiate a favorable bandwidth provider arrangement. Four disparate networks are at work in building 100, each requiring its own maintenance and IT attention. As new technology comes along requiring network upgrades to take advantage of, each tenant will have to decide whether to bear the upgrade costs entirely on its own or to continue on with older and less efficient technology. Many tenants will choose the latter in order to avoid additional capital expenditures. Meanwhile, the owner of building 100 has a building full of piecemeal, undocumented and many old and nonfunctioning networks.

The present invention changes this paradigm by providing an integrated building optical network (“BON”). The BON is an integrated fiber optics communication network that provides standards-based network connectivity to all portions of a building. Fiber optics is preferred due to the greater speed, capacity and reliability relative to traditional copper wire networks. The BON comprises all infrastructure (conduits, fiber optic backbone and wires, etc.) and equipment (switches, routers, access points, etc.) needed for data delivery.

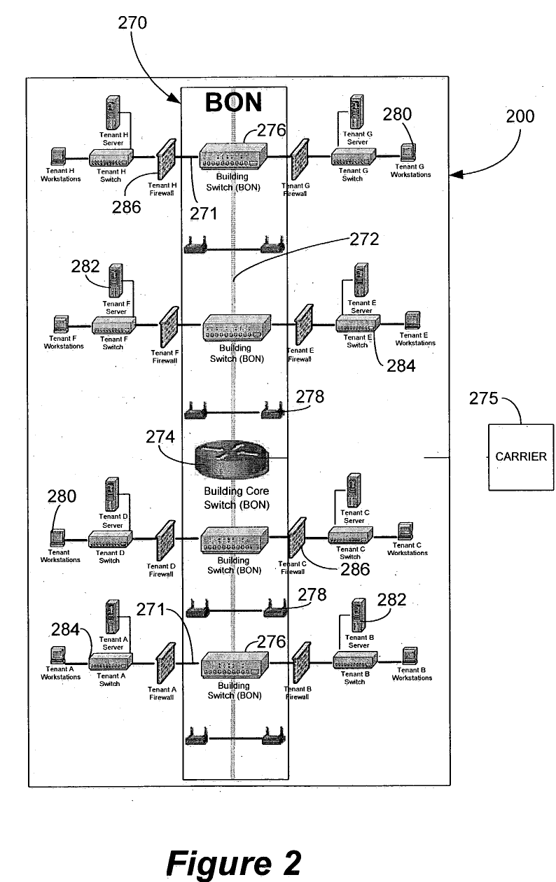

An exemplary BON 270 installed in an office building 200 is illustrated in FIG. 2. BON 270 comprises fiber optic backbone 272 extending through the riser space of building 200, and associated high quality (CAT 5-6) wiring 271. BON 270 also comprises a building core switch 274 coupled to backbone 272. Bandwidth is aggregated and delivered to building 200 in bulk at core switch 274 by an outside carrier 275 such as, for example, SBC, Worldcom, Qwest or Level (3). Building switches 276 positioned along backbone 272 are also part of BON 270 and serve to deliver bandwidth to individual tenants in building 200. Wireless access (Wi-Fi) points 278 are optionally coupled to backbone 272 to provide Wi-Fi access throughout building 200. The BON infrastructure and equipment is typically owned by the owner of building 200.

Tenant equipment such as workstations 280, servers 282, switches 284 and firewalls 286 is coupled to BON 270 via high quality CAT 5-6 wiring extending between the tenant equipment and fiber optic backbone 272. Tenant equipment may include other items (not shown) such as telephones, fax machines, and so on. It should be understood that the BON configuration depicted in FIG. 2 is for illustrative purposes only and that many other configurations are possible and within the scope of this invention. Much will depend on the design and architecture of the building or facility in question. Backbone 272 need not run through the center of the building and the BON equipment may not be uniformly distributed. More than one building core switch may be provided for interfacing to outside service providers and they may be at locations other than that depicted.

Another aspect of BON 270 is the provision of multiple wireless LAN or “Wi-Fi” access points 278 that are compliant with the IEEE 802.11× standard. Preferably, access points 278 are dispersed in a manner to provide wireless network access at any location in building 200. Anyone with a Wi-Fi-enabled laptop, PDA, web tablet, pocket PC or other such device will have instant, high-speed, wireless network and Internet access throughout the building. Tenants and visitors, as well as building security and maintenance personnel will be able to access network services from any point within building 200. The building-wide Wi-Fi network will enable such amenities as wireless Internet for tenants and visitors, wireless building security and camera surveillance systems, and wireless work order systems. As shown, there are two access points 278 per floor. It should be understood, however, that many other configurations are possible and alternative configurations may be desirable for providing blanket building coverage. Conversely, it may be desired to provide only certain portions of building 200 with Wi-Fi coverage. All such configurations are within the scope of this invention.

Providing office building 200 with BON 270 has many advantages relative to conventional network configuration and access schemes such as that depicted in FIG. 1. A modern fiber optics network extending throughout the building provides greatly increased speed, reliability and increased bandwidth. Each tenant or occupant of the building has direct access to high speed and high capacity broadband services, including Internet, e-mail, data, voice, video, web hosting and other services. Basic service of up to 10 Mbps (seven times as fast as typical T-1 speed), scalable to 1 Gpbs, can easily be provided.

Building owners are able to aggregate bandwidth and in essence deliver it as a fourth utility. The buying power of the entire building can be advantageously used to negotiate better telephone, Internet access, etc. rates with outside service providers. Buying bandwidth off the “bandwidth grid” is like buying power off the power grid. Service providers compete at the street for the right to deliver bandwidth as a utility to the entire building, rather than competing within the building for the business of individual tenants. Bandwidth costs to tenants may be lowered by a factor of five or more. As shown in FIG. 2, the building owner or agent may purchase network bandwidth in bulk from a sole service provider 275. Alternatively, network redundancy from multiple tier one carriers can be provided.

The advantages provided by bandwidth aggregation can best be appreciated by comparing bandwidth provisioning and cost in a scenario where multiple third party carriers and networks are involved (such as the scenario in FIG. 1), with bandwidth provisioning and cost in a scenario where a BON and one third party carrier are involved (such as the scenario in FIG. 2).

First, consider a building with 30 tenants where each tenant makes its own bandwidth purchase via its own T-1 line (the scenario of FIG. 1). Hence, there will be 30 bandwidth purchases over 30 T-1 lines. A tenant might typically purchase bandwidth capacity in the amount of 1.5 Mbps. Although this amount of capacity would rarely be needed, it is important to the tenant that such capacity be available when it is needed. This amount of access can be expected to cost approximately $900.00/month for each tenant, for a grand total of $27,000/month for all 30 tenants. A total of 45 Mbps (1.5*30) has been purchased, but on average probably only 2 Mbps (building-wide) is used.

Next, consider a building having a BON with 30 tenants. The bandwidth needs of all tenants is aggregated, and a bulk bandwidth purchase is made. Here, it is determined that 5 Mbps will be enough to accommodate the needs of all 30 tenants, and this is purchased in bulk for the building at a cost of $2,000/month. Again, only about 2 Mbps building-wide is used. So, the bandwidth needs of all tenants have been more than accommodated, at a significant ($27,000 vs. $2,000) savings.

The Building Optical Network (BON) of the present invention also enables building owners to integrate building systems and to centralize and automate network maintenance and tenant IT. Building network, security, HVAC, fire, safety, elevators, maintenance, environmental and other systems can be seamlessly integrated. The building or IT manager can have a central website, for example, from which tenants can report problems, request service, view the status of building facilities/amenities or request assistance from the building concierge (cab, food delivery, reservations, etc.). The entire network can be managed and maintained remotely by a single network manager to guarantee quality of service. Web-based ticket work order systems, web-based provisioning and web-based monitoring can be provided. Additionally, the network may be partitioned with different levels of security and access.

Again, the benefits of automated IT services can be best appreciated by comparing an individual network scenario to a BON scenario. Where individual networks are used, 30 tenants will equate to 30 servers and 30 IT staffers. Each tenant will have network support only during the typical working hours of the IT staff (e.g., 8 a.m. to 6 p.m.). Where a BON is deployed, conversely, 30 tenants will equate to only one IT staffer who manages the entire BON. The staffer can be paid by the building owner to provide 7/24/365 service. In an alternative embodiment to that illustrated in FIG. 2, the tenant servers could be integrated into one single server. Hence, all tenant needs are met by one server managed by one IT staffer.

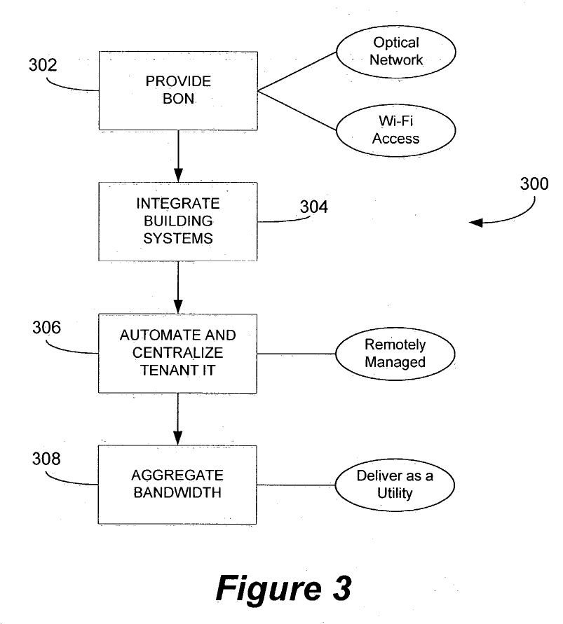

FIG. 3 illustrates a method 300 for providing network access to a building or other location or facility where multiple points of access to a high speed network is desired. In step 302, a building optical network (BON) is provided. The BON is preferably a high speed fiber optic communications network with Wi-Fi access points, as depicted with reference to FIG. 2. In step 304, the communications network is integrated with other building networks such as security, maintenance, etc. In step 306, network maintenance and tenant IT needs are automated and centralized. The network may be remotely managed by an off-site (or on-site, if preferred) network manager. To implement steps 304 and 306, a central website may be provided from which tenants can report problems, request service and view the status of building facilities/amenities.

In step 308, network access or bandwidth is “aggregated” for the tenants and/or occupants of the building. As previously described, service carriers compete at the street for the right to meet the bandwidth needs of the entire building rather than tenants individually. The building owner (or the network manager, as will be described below) then provides the bandwidth to tenants as needed in a manner akin to the provision of utilities such as water, gas and electricity.

In a preferred embodiment of the invention, a third party network coordinator oversees the design, installation and management of the BON. The network infrastructure is owned and controlled by the building owner but is managed and maintained by the network coordinator, just as electrical networks and equipment are managed and maintained by an electric company. The network coordinator may be thought of as a “bandwidth utility company”. Optical fibers and switches are treated like electrical wires and transformers, owned by the building and managed by a third party. The building owner compensates the network coordinator for its services, but will recovers its costs many times via the ability to charge increased lease rates (due to the attractiveness of an “instant” high speed network) and increased property value.

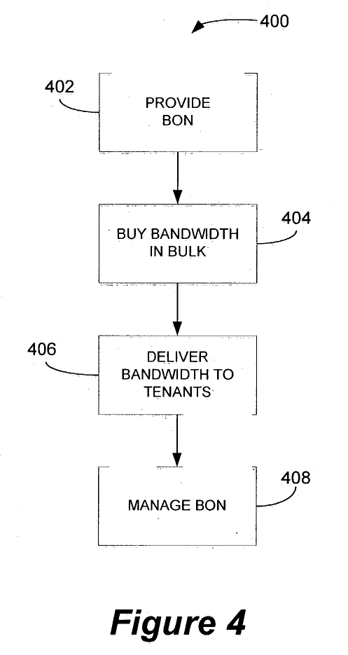

FIG. 4 illustrates a method 400 for the provision of network infrastructure and access to a building by a network coordinator. In a preferred embodiment, the network coordinator is a third party that oversees: the design, installation and management of the network for the benefit of the building owner. Alternatively, the network coordinator could be the building owner itself. In step 402, the network coordinator oversees the design and installation of the BON. The BON is preferably a fiber optics communication network that provides network connectivity to all portions of building. Most preferably, the BON also includes Wi-Fi access points configured to provide wireless network access throughout the building.

In step 404, the network coordinator negotiates with outside network service providers for the bandwidth needs of the entire building. The buying power of the entire building is advantageously used to obtain favorable terms on the amount of network access and bandwidth needed. In step 406, the network coordinator delivers the needed levels of bandwidth and network access to the individual building tenants. In a preferred embodiment, the network coordinator sells the network access to the tenants with a built-in profit margin; with the cost of the network access still being less than what the tenant could have negotiated individually.

Finally, in step 408, the network coordinator manages the BON. This includes all network management, servicing, upgrade and IT functions. The need for individual tenants to hire their own IT professionals is eliminated, and the building network runs more smoothly and efficiently than conventional, piecemeal networks. All changes and upgrades to the network are documented so that the building owner always has a current map of his BON. The network coordinator may set up a central website to coordinate building/tenant/network coordinator communications.

While various embodiments of the invention have been described, it will be apparent to those of ordinary skill in the art that many more embodiments and implementations are possible that are within the scope of this invention.

What is claimed is:

1. A method for providing network access to a building comprising:
providing a high speed, integrated communications network that provides network connectivity throughout the building;
integrating the communications network with other building systems;
automating and centralizing network management and maintenance in a network manager; and
aggregating the network bandwidth needs of the building and delivering the network bandwidth to building tenants as needed.

2. A method as claimed in claim 1, wherein the communications network is a fiber optics network.

3. A method as claimed in claim 2, wherein the communications network comprises a plurality of wireless LAN access points.

4. A method as claimed in claim 1, wherein the network manager operates a central website from which building tenants can report network issues and request service.

5. A method as claimed in claim 4, wherein the central website also provides access to other building services and amenities.

6. A method for delivering network bandwidth as a utility to a multi-occupant facility comprising:
coordinating the design and installation of a high speed fiber optics communications network that provides wired and wireless network connectivity throughout the facility;
obtaining network bandwidth in bulk to meet the bandwidth needs of all occupants of the facility;
delivering the network bandwidth to the occupants of the facility as needed; and
maintaining, managing and servicing the communications network.

7. A method as claimed in claim 6, wherein the network bandwidth is sold to the occupants of the facility with a built-in profit margin.

8. An integrated data communications network for an office building comprising:
fiber optics network infrastructure and equipment for providing network connectivity throughout the building;
a single point of access for provision of bandwidth by network service providers;
automated and centralized network management and maintenance; and
wireless LAN access points configured to provide wireless network access throughout the building.
